(19) United States
(12) Patent Application Publication
(10) Pub. No.: US 2025/0204662 A1
(43) Pub. Date: Jun. 26, 2025

(54) Thermal Insulating Protective Case Covers For Musical Instrument Cases

(71) Applicant: Bai Art Collective LLC, New York, NY (US)

(72) Inventor: Liuqing Zheng, New York, NY (US)

(73) Assignee: Bai Art Collective LLC, New York, NY (US)

(21) Appl. No.: 18/395,724

(22) Filed: Dec. 25, 2023

(51) Int. Cl. A45C 13/00; G10G 7/00

(52) U.S. Cl. CPC A45C 13/002; G10G 7/005

(57) ABSTRACT

The invention is a protective cover made of thermal insulating material such as goose or duck down, or synthetic down, filled in fabric shell, which covers the protective hard case of musical instruments such as violins, violas and cellos, to protect musical instrument from the impact of weather elements such as cold or heat. The embodiments of this invention are adapted to the different shapes and sizes of the musical instrument cases, as well as the specific configurations such as the location of the case straps and handles.

### BACKGROUND OF THE INVENTION

Musical instruments, especially stringed instruments such as violins, violas and cellos, are very sensitive to the weather elements such as temperature and humidity. These elements have a range of impact on the instruments, ranging from sound quality change to developing physical damage such as cracks or open seams. These instruments are usually stored in protective hard cases which protect the instruments from the acute physical impact such hitting or dropping rather than the impact of subtle weather elements. There's no existing case cover that can achieve the following at the same time: thermal insulation, having the flexibility of being installed onto and removed from the case with each use, fit to any size of the case, and can adapt to the existing case characteristics, such as the shape and size of the case, as well as the location of the straps and handles of the case. This invention addresses all of the above.

### SUMMARY OF THE INVENTION

The invention is a protective cover that's made of thermal insulating material such as goose or duck down, which covers the protective hard case of musical instruments such as violins, violas and cellos while being secured on the case using the system described the details and illustrated in the drawings. The design of which is unique and does not exist previously. The invention is specific to the way in which the cover is secured on the instrument's hard case and the material used to achieve thermal insulation. There has been no prior case cover that's either made with such thermal insulating material or use this method to be secured on the case as described below.

The case cover is secured on to the case by the buckle and straps, which are connected to the main structure of the case cover by two pieces of fabric. The main structure of the case cover, is the thermal insulating part of the cover, which covers the front, sides and part of the back of the case. It's made with fabric filled with goose or duck down, or synthetic down. There're two zippers on the two sides of the lower back of the case cover. The combination of the straps, buckle and zippers, allow for the case cover to open and be installed onto and removed from the case. The cover will be removed from each use in order to open the case. Depending on the specific instrument case, there may be openings on the side(s) or back of the cover, to allow case straps or case handle to go through.

The main structure of the cover, which covers the front, sides and part of the back of the case, can be made of any fabric such as nylon or polyester, filled with thermal insulating material such as goose or duck down, or synthetic down.

The embodiments of this invention are adapted to the different shapes and sizes of the musical instrument cases, as well as the specifics configurations such as the location of the case straps and handles. The shape or size of the instrument case is irrelevant to the invention, as the designed functionality can be adapted to any shape or size of case. The location of the case handle, or case straps are irrelevant as the opening(s) on the side(s) of the cases can be adapted to the location where the handle or straps are connected to the case.

### BRIEF DESCRIPTION OF DRAWINGS

FIGS. 1-7 are drawings that use one type of oblong shaped cases as example, to illustrate the way in which the case cover is secured on the instrument case, and the visual appearance of the case cover made of the thermal insulating material, such as goose or duck down or synthetic down, filled in fabric shells. The shell material may be made with any fabric. The pattern of the stitches (horizontal stripes as illustrated) may be any kind, for example, the stripes may be vertical, run along the long side rather than the short side of the cover, or they might not be straight lines.

FIGS. 9-16 are drawings that don't display the visual appearance of the thermal insulating material, but emphasize on showing the method in which the case cover is secured on the case, adapting to any shape of the case, including but not limited to some of the most common shapes of instrument cases as shown in the drawings. They also illustrate that the embodiments of this invention are adapted to the different shapes and sizes of the musical instrument cases, as well as the specific configurations such as the location of the case straps and handles. The shape or size of the instrument case is irrelevant to the invention, as the designed functionality can be adapted to any shape or size of case. The location of the case handle, or case straps are irrelevant as the opening(s) on the side(s) of the cases can be adapted to the location where the handle or straps are connected to the case.

### DETAILED DESCRIPTION OF THE INVENTION

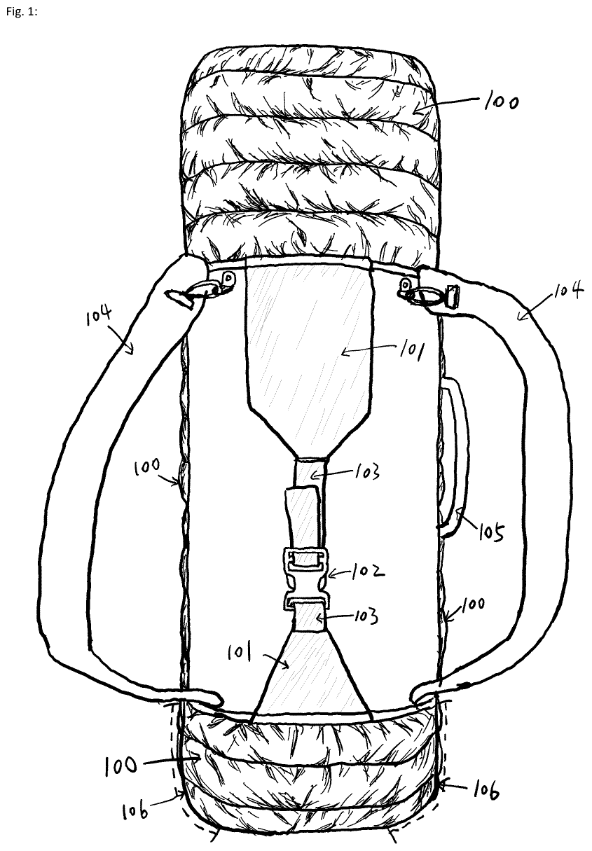

FIG. 1: The back view of the case cover, when it's installed on the case, with case straps (104) and case handle (105) showing. The view included the main structure (100) of the case cover, and the two pieces of fabric (101) that connect the buckle (102) and straps (103) to the main structure of the cover. The two zippers (106), invisible when zipped/closed, are located at lower two size of the case cover, the length of location of which are demonstrated with the dashed line.

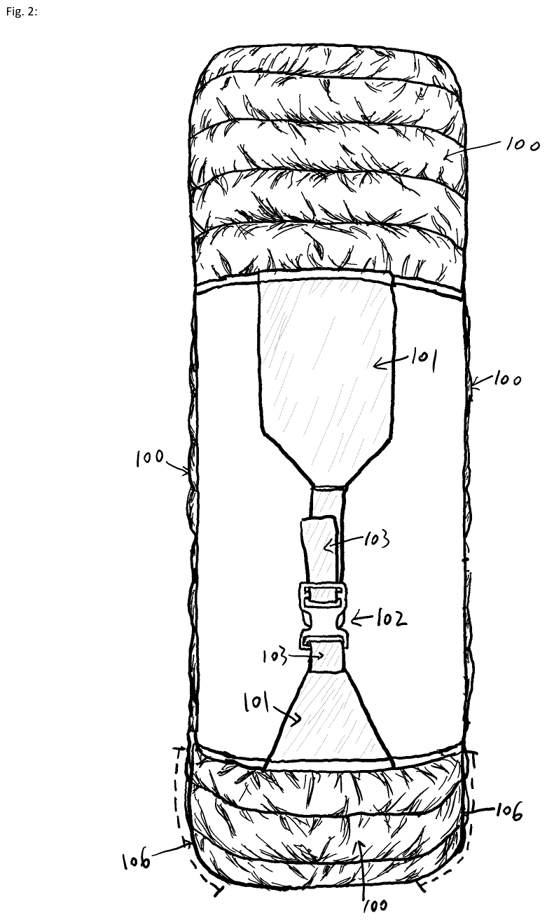

FIG. 2: The back view of the case cover, without any component of the case, showing the main structure (100) of the case cover, and the two pieces of fabric (101) that connect the buckle (102) and straps (103) to the main structure of the cover. The two zippers (106), invisible when zipped/closed, are located at lower two size of the case cover, the length of location of which are demonstrated with the dashed line.

FIG. 3: Front view of the case cover, when it's installed on the case, showing the front side of the main structure (100) of the case cover and the case handle (105).

FIG. 4: Front view of the case cover, without any component of the case, showing the front side of the main structure (100) of the case cover.

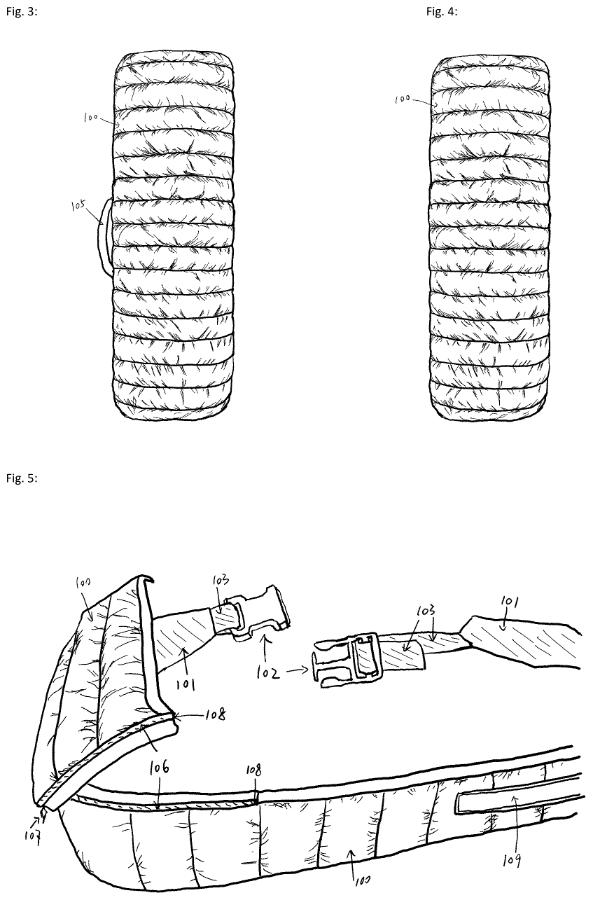

FIG. 5: Side view of the case cover, when it's installed on the case, showing case strap (104), the main structure (100) of the case cover, and the opening (109) on the side of the case cover that allows case handle to go through. The location of the two pieces of fabric (101) that connect the straps (103) and buckle (102) are as labeled.

FIG. 6: Side view of the case cover without any component of the case, showing the main structure (100) of the cover and the opening (109) on the side of the case cover that allows case handle to go through.

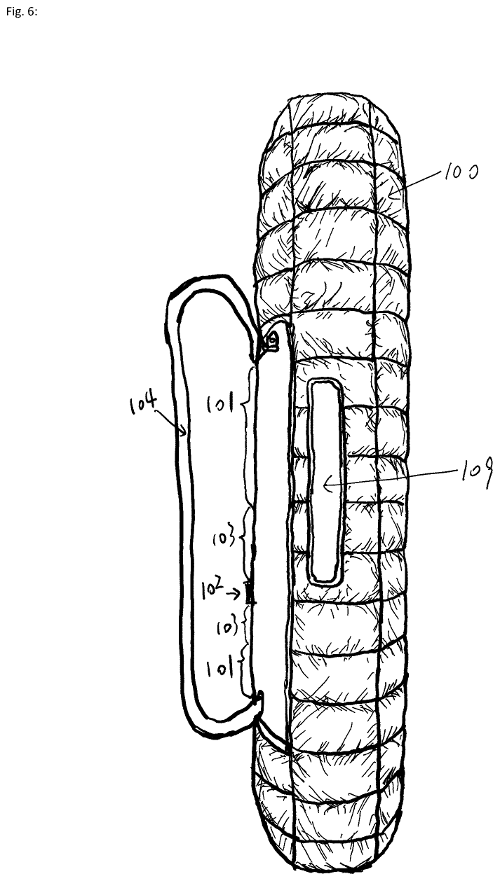

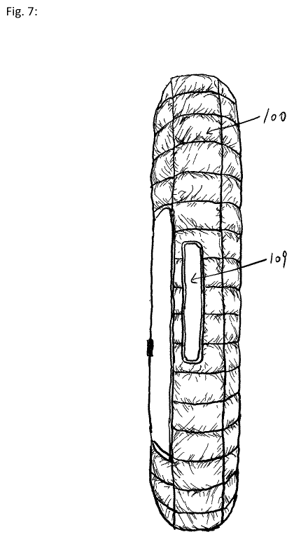

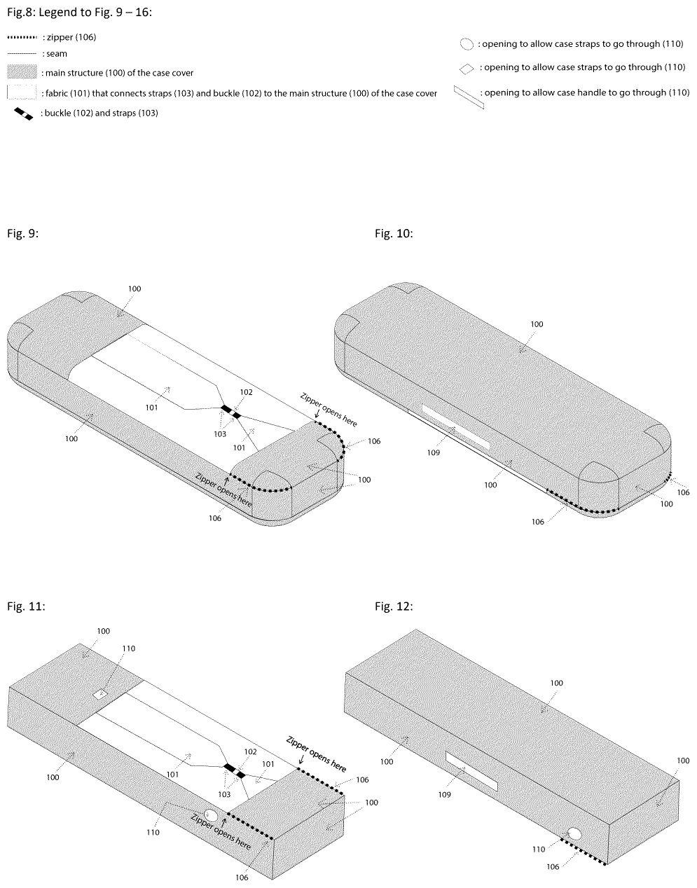

FIG. 7: Close up view of when the buckle (102) and zippers (106) are open. The location of the zipper's top stop (108) is as illustrated. The zipper's slider (107) is at the bottom end of the zipper. The two zippers (showing only one in this view) are symmetrical. The exact zipper locations are also illustrated in FIG. 9, FIG. 11, FIGS. 13 and 15.

FIG. 8: legend to FIGS. 9-16.

FIG. 9: Back view of the case cover for oblong shaped case with round corners, which is the same type of case as in FIGS. 1-7.

FIG. 10: Front view of the case cover for oblong shaped case with round corners, which is the same type of case as in FIGS. 1-7.

FIG. 11: Back view of the case cover for oblong shaped case.

FIG. 12: Front view of the case cover for oblong shaped case.

FIG. 13: Back view of the case cover for contoured case, with the openings (110) that allow the case straps to go through on the side of the case.

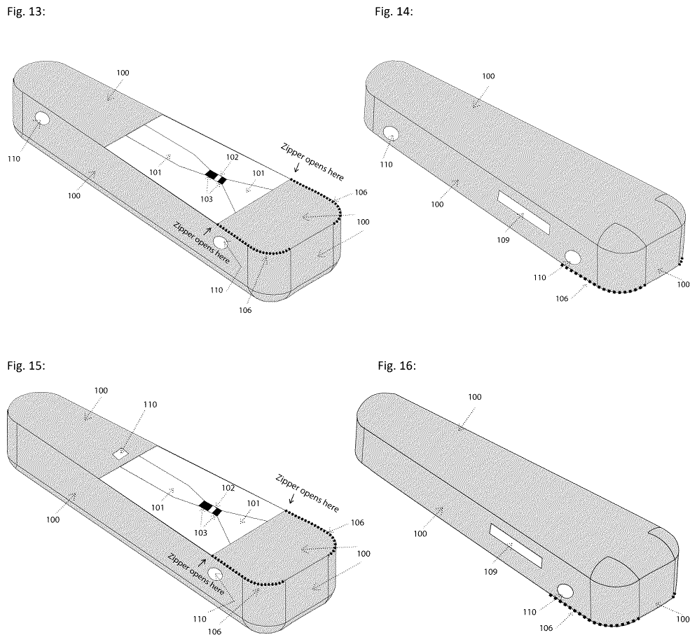

FIG. 14: Front view of the case cover for contoured case, with the openings (110) that allow the case straps to go through on the side of the case.

FIG. 15: Back view of the case cover for contoured case, with the openings (110) that allow the case straps to go through on the lower sides and the top center back of the case.

FIG. 16: Front view of the case cover for contoured case, with the openings (110) that allow the case straps to go through on the lower sides and the top center back of the case.

The dictionary of the numbering in the drawings are as follows:
100: Main structure of the case cover, made with the thermal insulating material, such as goose or duck down or synthetic down, filled in fabric shell. The fabric shell can be made with any kind of fabric such as nylon or polyester.
101: The fabric that connects the straps and buckle to the main structure of the case cover.
102: Buckle
103: Straps
104: Case straps, for illustration only, not part of the invention
105: Case handle, for illustration only, not part of the invention
106: Zipper(s)
107: Slider of the zipper(s)
108: Top end (opening side) of the zipper(s)
109: Opening(s) on the case cover for allowing case handle to go through.
110: Opening(s) on the case cover for allowing case straps to go through. In some embodiments of the case cover, they're not needed.

1. Musical instrument case covers comprising of: a thermal insulating main structure that covers the protective hard case of musical instruments such as violins, violas and cellos; two pieces of fabric which connect the main structure of the case cover to two straps, a buckle with each end connected to each of the straps, and two zippers that allows the lower side of the back of the case cover to open.

2. The method in which the case cover is secured on the instrument case, regardless of the shape of the case, specifically, using straps and a buckle along the long side of the back of the case, with two pieces of fabric, regardless of their shapes, connecting the straps to the main structure of the case cover, combined with the zippers on the two lower sides of the case as demonstrated in the drawings, which serve as the critical parts, in allowing the case cover to be secured onto and removed from the case.

3. The method in which the case cover achieves thermal insulation, which is using fabric shell filled with thermal insulating material such as goose or duck down, or synthetic down filling.
